(19) United States
(12) Patent Application Publication
(10) Pub. No.: US 2018/0092147 A1
(43) Pub. Date: Mar. 29, 2018

(54) CONTROL PLANE METHOD AND APPARATUS FOR WIRELESS LOCAL AREA NETWORK (WLAN) INTEGRATION IN CELLULAR SYSTEMS

(71) Applicant: InterDigital Patent Holdings, Inc., Wilmington, DE (US)

(72) Inventors: Ghyslain PELLETIER, Montreal (CA); Diana PANI, Montreal (CA); Guanzhou WANG, Brossard (CA); Pascal M. ADJAKPLE, Great Neck, NY (US)

(73) Assignee: InterDigital Patent Holdings, Inc., Wilmington, DE (US)

(21) Appl. No.: 15/564,625

(22) PCT Filed: Apr. 8, 2016
(86) PCT No.: PCT/US2016/026627

§ 371 Date: Oct. 5, 2017

Related U.S. Application Data
(60) Provisional application No. 62/144,708, filed on Apr. 8, 2015.
(60) Provisional application No. 62/161,012, filed on May 13, 2015.

(51) Int. Cl. H04W 76/02; H04W 12/06; H04L 29/06; H04W 12/04

(52) U.S. Cl. CPC H04W 76/025; H04W 12/06; H04W 84/042; H04L 63/068; H04W 12/04; H04L 63/0846

(57) ABSTRACT

A method and apparatus for configuring a Long Term Evolution (LTE)-controlled Wireless Local Area Network (WLAN) interface for a wireless transmit/receive unit (WTRU) are described. A method includes receiving LTE Radio Resource Configuration (RRC) signaling that provides parameters for the WTRU to configure the LTE-controlled WLAN interface. The LTE RRC signaling includes a set of WLAN access points (APs), an indication that the WTRU is permitted to autonomously initiate association with a WLAN within the set, a type of one or more bearers to use for the LTE-controlled WLAN interface, WLAN-related security information, and a configuration for the WTRU to report a status of an association with a WLAN AP. The WTRU selects a WLAN AP to associate to from the list and initiates association to the selected WLAN AP using at least the WLAN-related security information.

### CROSS REFERENCE TO RELATED APPLICATIONS

This application claims the benefit of U.S. Provisional Patent Application No. 62/144,708, which was filed on Apr. 8, 2015, and U.S. Provisional Patent Application No. 62/161,012, which was filed on May 13, 2015, the contents of which are hereby incorporated by reference herein.

### BACKGROUND

Mobile data offloading may make use of complementary network technologies, such as wireless fidelity (Wi-Fi), to deliver data originally targeted for cellular networks. Mobile data offloading may, therefore, be effective to free up cellular bandwidth for other users because it may reduce the amount of data being carried on the cellular bands. Mobile data offloading may also be used where local cellular reception is poor by allowing a user to connect to the cellular network via wired services with better connectivity.

### SUMMARY

A method and apparatus for configuring a Long Term Evolution (LTE)-controlled Wireless Local Area Network (WLAN) interface for a wireless transmit/receive unit (WTRU) are described. A method includes receiving LTE Radio Resource Configuration (RRC) signaling that provides parameters for the WTRU to configure the LTE-controlled WLAN interface. The LTE RRC signaling includes a set of WLAN access points (APs), an indication that the WTRU is permitted to autonomously initiate association with a WLAN within the set, a type of one or more bearers to use for the LTE-controlled WLAN interface, WLAN-related security information, and a configuration for the WTRU to report a status of an association with a WLAN AP. The WTRU selects a WLAN AP to associate to from the list and initiates association to the selected WLAN AP using at least the WLAN-related security information.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network (RAN) and an example core network (CN) that may be used within the communications system illustrated in FIG. 1A;

FIG. 2 is a system diagram of an example system employing both co-located and non-colocated scenarios for a Long Term Evolution (LTE) RAN node and a Wireless Local Area Network (WLAN) access network node (AP);

FIG. 3 is a block diagram of an example system showing split of downlink data above the Packet Data Convergence Protocol (PDCP) layer;

FIG. 4 is a block diagram of an example system showing split of downlink data within the PDCP layer ;

FIG. 5 is a diagram of a system with integrated WLAN AP and eNodeB (eNB) with a proprietary interface;

FIG. 6 is a diagram of a system in which the WLAN AP and eNB are physically separated with a standardized interface;

FIG. 7 is a diagram of a system in which the WLAN AP and eNB are physically separated without an interface;

FIG. 8 is a signal diagram showing basic Radio Resource Control (RRC) Reconfiguration signaling that may be used for any of the embodiments described herein; and

FIG. 9 is a signal diagram of an example of a security procedure for LTE and WLAN integration using network-assisted key assignment.

### DETAILED DESCRIPTION

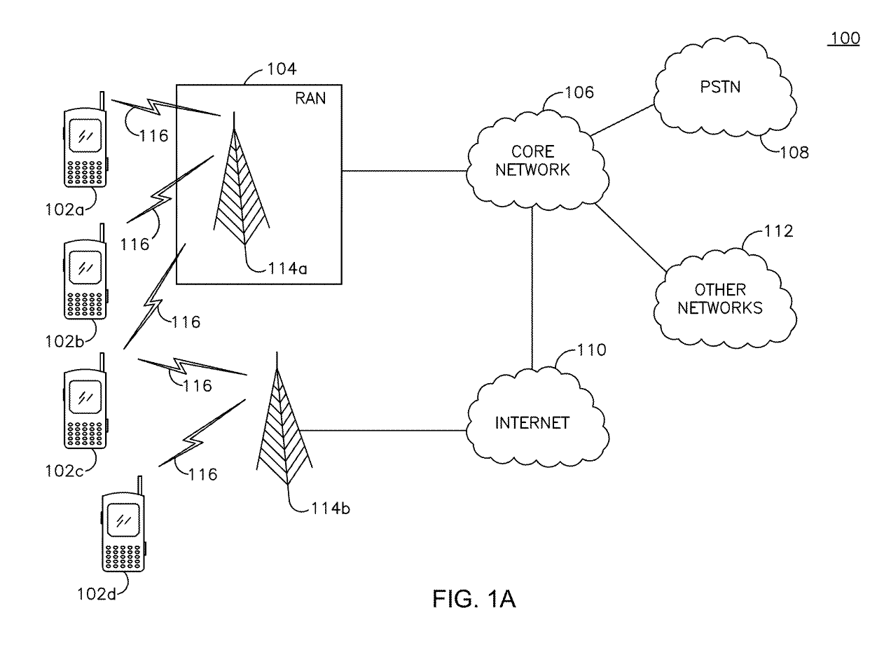

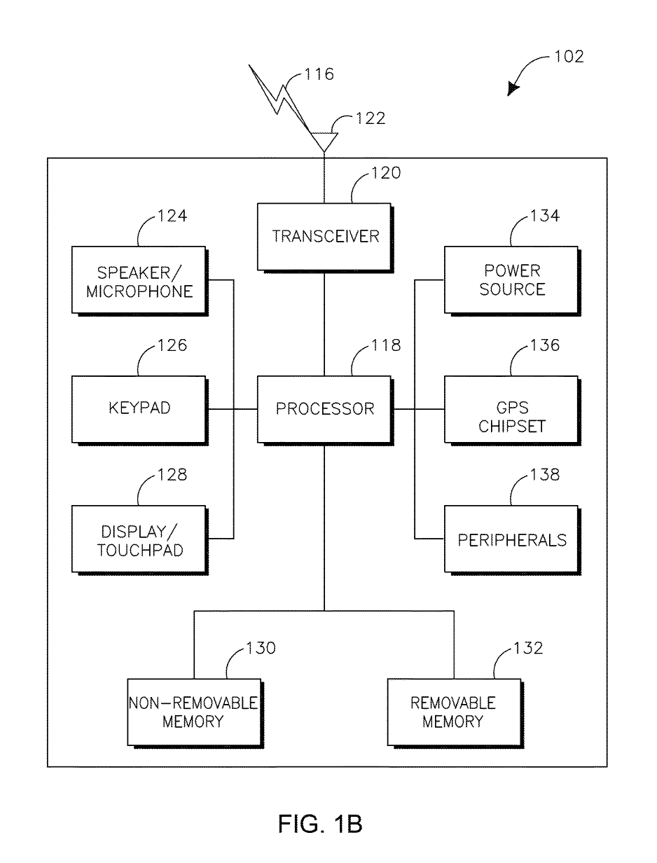

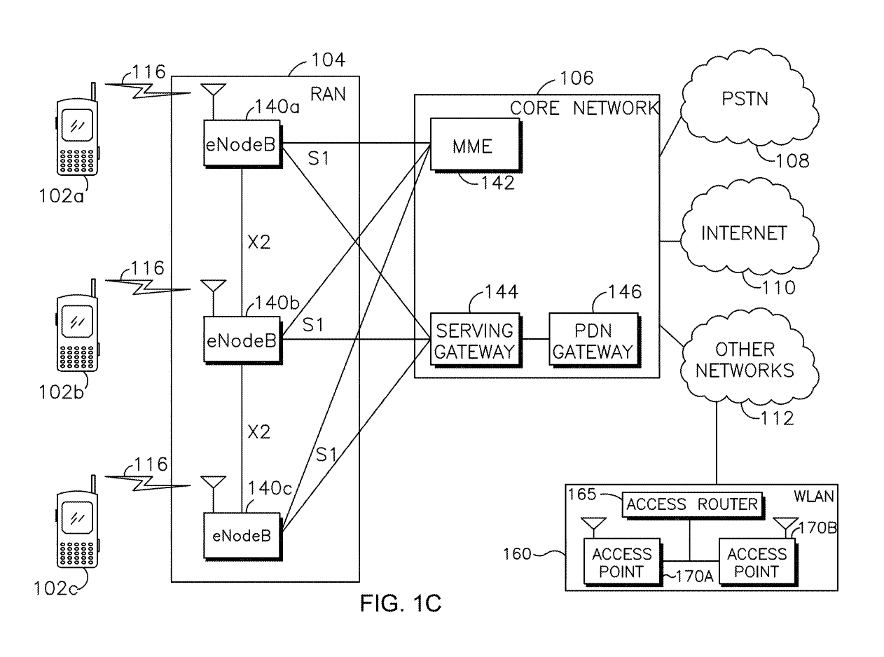

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple-output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the clisplay/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management entity gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an Si interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Other network 112 may further be connected to an IEEE 802.11 based wireless local area network (WLAN) 160. The WLAN 160 may include an access router 165. The access router may contain gateway functionality. The access router 165 may be in communication with a plurality of access points (APs) 170a, 170b. The communication between access router 165 and APs 170a, 170b may be via wired Ethernet (IEEE 802.3 standards), or any type of wireless communication protocol. AP 170a is in wireless communication over an air interface with WTRU 102d.

Previous proposals for mobile data offloading have focused on attempts to an enable a WTRU to access evolved packet core (EPC) packet switched (PS) services using WLAN. Using such offloading mechanisms, the RAN plays little role.

More recently, Third Generation Partnership Project (3GPP)/WLAN interworking has been enhanced by the introduction of a WLAN selection and traffic steering mechanism that uses RAN-based rules. Further, some Access Network Selection and Discovery Function (ANDSF) policies have been extended with RAN and WLAN thresholds. Such thresholds may be provided to the WTRU by the RAN or the ANDSF server. Using such mechanisms, however, traffic may only be offloaded on a per-PDN basis. Based on user subscription data, the MME may determine which PDNs are offloadable and indicate the offloadability information to the WTRU using Non-Access Stratum (NAS) signaling. Further, such mechanisms may enable the RAN to have certain control over WTRU WLAN offloading by adjusting the thresholds. However, the offloading decision is still a WTRU function.

A trend is developing in the industry in which network operators are beginning to roll out their own Wi-Fi networks, and there may be technical and operational advantages for them to integrate a WLAN AP with their base stations, such as eNBs. This may be particularly attractive for deployments of small cells overlay. The co-located eNB/AP scenario may enable the possibility for proprietary inter-node communication between the eNB and AP and may also open up the possibility for additional mechanisms for Wi-Fi offloading to achieve more throughput and better user experience.

Potential control and user plane mechanisms have been suggested for both the co-located and non-colocated scenarios. For example, the control plane could be anchored in the eNB while the user plane could be aggregated above the medium access control (MAC) layer. In another example, aggregation functions may be performed at the Radio Link Control (RLC) layer.

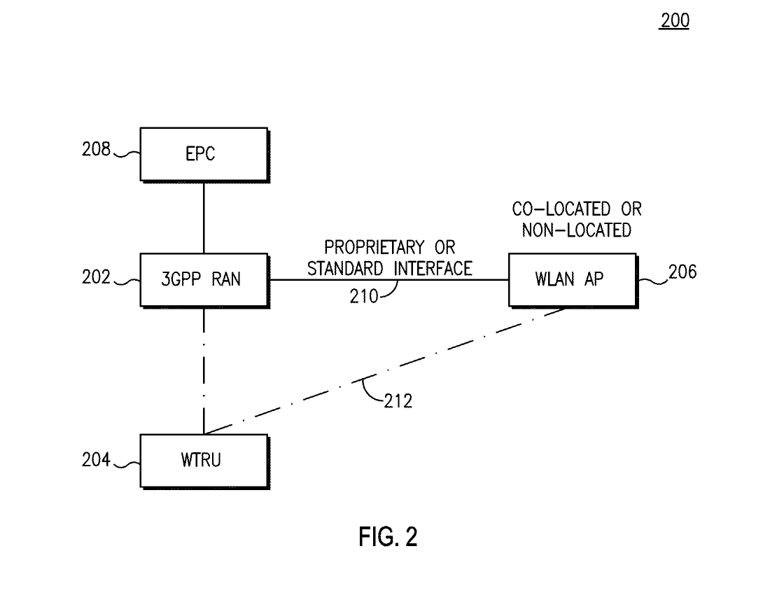

FIG. 2 is a system diagram of an example system 200 employing both co-located and non-colocated scenarios for an LTE RAN node and a WLAN access network node (AP). In the example illustrated in FIG. 2, for the co-located scenario, the LTE RAN node 202 (e.g., an eNB) and the WLAN AP 206 may be logically co-located, and the interface 210 between them may be internal and proprietary. For the non-colocated scenario, the LTE RAN node 202 and WLAN AP 206 are not co-located, and there may be a standard interface 210, or no interface, between them. In both scenarios, the interface 210 may include a WLAN-specific controller or controlling function that may manage or hide multiple APs. In the illustrated example, data originating from the WTRU 204 intended for the EPC 208 via the LTE RAN node 202 may be offloaded via the WLAN AP 206 in certain circumstances, as indicated by the dashed line 212 in FIG. 2.

With regard to the user plane, two options have been proposed regarding where it should be anchored. In RAN-based anchoring, for a given bearer (e.g., an evolved packet system (EPS) bearer), the user plane may be anchored at the eNB. Downlink traffic may be delivered to the eNB associated with the WTRU's connection through the General Packet Radio Service (GPRS) tunneling protocol (GPT)-based tunnel. The eNB may then distribute the downlink traffic either over the Uu interface, over the WLAN interface, or both (if at least one of redundancy and retransmissions are supported). The decision as to which one to use may be based, for example, on rules configured in the eNB. Traffic may be routed using different combinations of the Uu interface and the WLAN interface in terms of direction (uplink or downlink) and/or in terms of available interface. For example, traffic may use a single interface at a given time or may use both interfaces at the same time where split bearers are supported.

Anchoring the user plane at the eNB may avoid the need for an internet protocol (IP) solution for traffic over the WLAN link. Further, anchoring the user plane at the eNB does not necessarily imply that other offloading schemes, such as Multiple-Access PDN Connectivity (MAPCON), IP Flow Mobility (IFOM) and S2a mobility based on GPRS tunneling (SaMOG), in which the traffic does not pass through the eNB at all, cannot also be used in parallel.

Alternatively to anchoring the user plane at the eNB, the user plane may be anchored at the node that exclusively serves a particular bearer (e.g., either the eNB only or the WLAN AP only). The RAN node may control the mobility while the WLAN AP may have a direct connection (e.g., a GTP-based tunnel) to the CN or similar. Traffic may be routed using a single interface, for both downlink and uplink traffic, in many instances.

For further integration between RAN nodes and WLAN, methods and mechanisms may be needed for determining how user plane traffic should be handled and any additional methods and functions that may be needed to support such methods and mechanisms. For example, user plane modelling may determine at which layer the traffic is split or aggregated and how the eNB or WTRU determines which flows or bearers should be sent over the LTE Uu or over WLAN. Additional functions may be required in the layer in which the split occurs such that functions between that layer and the WLAN interface may be coherent and such that 3GPP Quality of Service (QoS)-related functions may be maintained (including, for example, reliability aspects). For example, the data could be split above, or within, one of the Packet Data Convergence Protocol (PDCP) layer, the RLC layer or even the MAC layer.

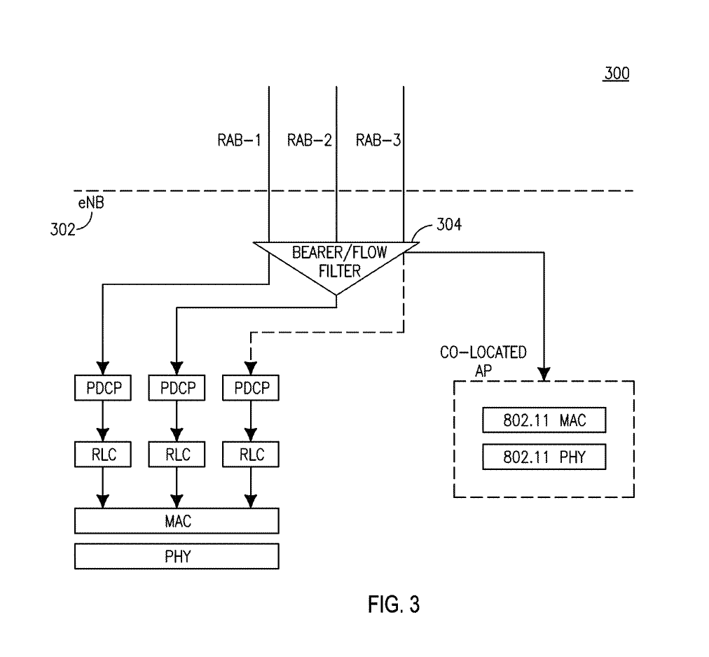

FIG. 3 is a block diagram of an example system 300 showing split of downlink (DL) data above the PDCP layer (e.g., IP-based routing). In the example illustrated in FIG. 3, the eNB 302 may have a filter function 304 to determine which of the two accesses traffic associated to a flow/bearer should use. The DL data of a radio bearer (RB), such as RAB-1, RAB-2 or RAB-3, may be entirely sent over the Uu interface (as illustrated for RAB-1 and RAB-2) or using the WLAN link based on the rules in the filter function Alternatively, part of the data of an RB may be sent over the Uu while the rest may be sent over the WLAN link (as illustrated for RAB-3). For traffic that is sent over WLAN, the IP packets may be retrieved from the S1-U packets and directly delivered in Institute of Electrical and Electronics Engineers (IEEE) 802.11 frames. On the WTRU side, the WTRU may receive IP packets on both links and submit them to the upper layer.

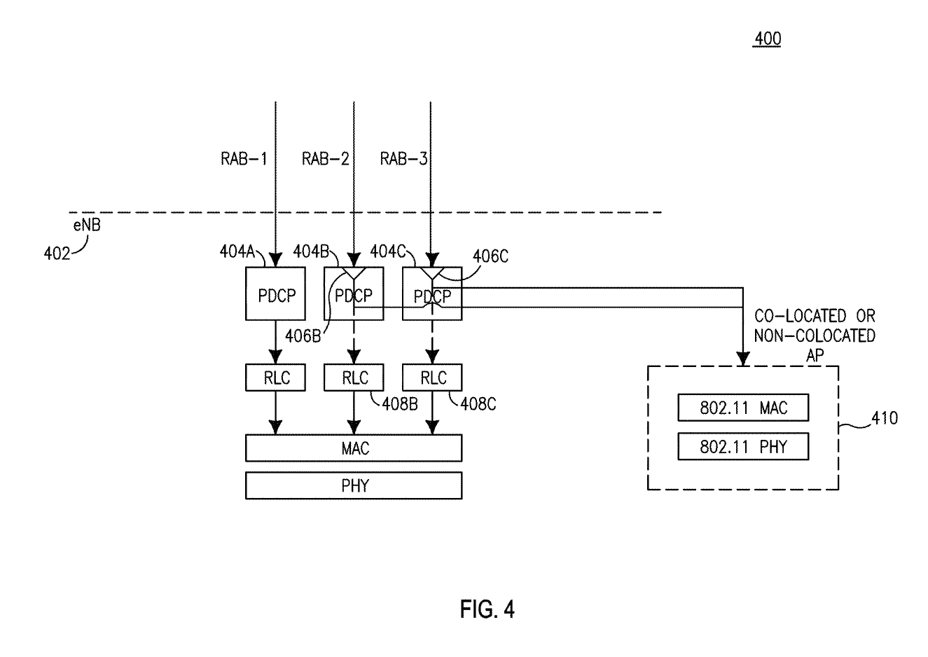

FIG. 4 is a block diagram of an example system 400 showing split of DL data within the PDCP layer (e.g., flow/filter-based routing). In the example illustrated in FIG. 4, if the offloading is per-bearer instead of per-flow, there is no need for a flow filter function (as illustrated for RAB-1). If the offloading is per flow, a filter/split function, such as filter functions 406b and 406c, may be included in the PDCP entities 404b and 404c, and data entering such PDCP entities may be sent to the underlying RLC entity 408b or 408c, respectively, or sent to the WLAN AP 410, depending on whether the flow is subjected to offloading. On the receiving side, the PDCP PDUs from the WLAN link may be collected by the corresponding PDCP entity and handled together with the PDCP PDUs received from the Uu link and submitted to the upper layer. Using this option, data sent over the WLAN link may still benefit from the compression and encryption functionalities at the PDCP entity. Similarly, data may be split or aggregated at the RLC or MAC layer.

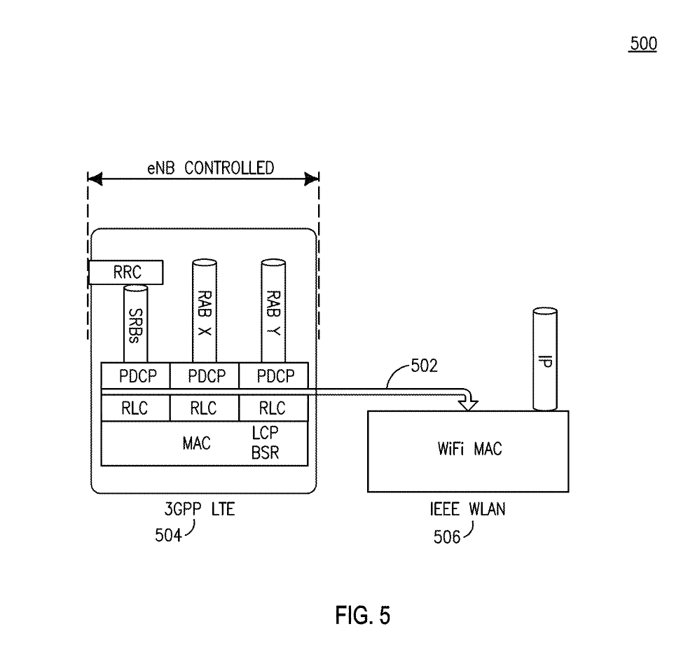

A number of different deployment scenarios for the combination of LTE and Wi-Fi are described herein, including an embodiment where the WLAN AP and eNB are integrated with a proprietary interface, where the WLAN AP and eNB are separated with a standardized interface, and where the WLAN AP and eNB are physically separated without an interface, such as was briefly mentioned above, but is described in more detail below with reference to FIGS. 5, 6 and 7.

FIG. 5 is a diagram of an example system 500 with integrated WLAN AP 506 and LTE eNB 504 with a proprietary interface 502. In the example illustrated in FIG. 5, from the perspective of the network, the implementation of the multiple radio accesses, such as the LTE and WLAN interfaces, may be physically co-located and coordination between the two entities may be facilitated using a proprietary interface 502. In such an embodiment, from the WTRU's perspective, the modelling of the user plane may be similar to that of carrier aggregation where the WLAN interface may be considered as an additional resource to the WTRU. This may be similar in principle to handling WLAN connectivity as a special cell of the WTRU's configuration. Such modelling may include support for transmitting data associated to a bearer (such as RABx or RABy) using the plurality of radio accesses. Restrictions for certain traffic or bearers may be introduced in some scenarios, for example, by configuration or using dynamic methods such as for uplink routing.

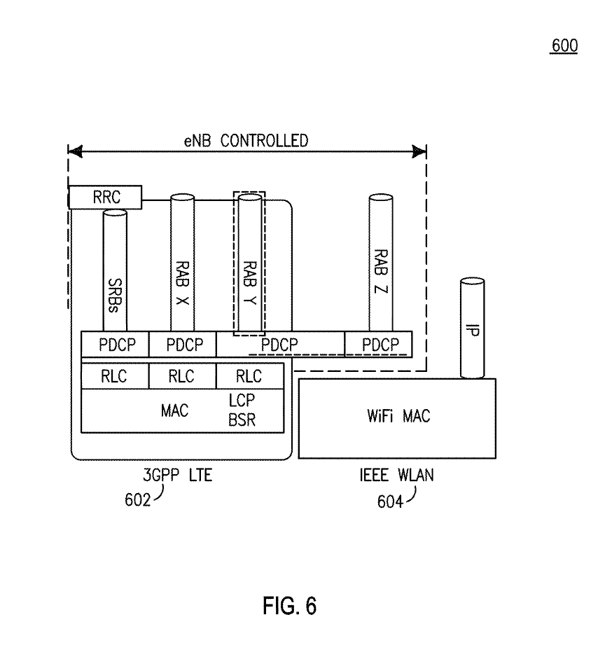

FIG. 6 is a diagram of an example system 600 in which the WLAN AP 604 and the LTE eNB 602 are physically separated with a standardized interface (not shown). In the example illustrated in FIG. 6, from the perspective of the network, the implementation of the LTE and WLAN interfaces may be physically separated, and at least some coordination between the two entities may be facilitated using a standardized interface. In such a case, from the WTRU's perspective, the modelling of the user plane may include support for bearers being associated with a plurality of radio accesses (such as RABy, which is associated to both LTE and WLAN) in additional to supporting bearers associated to a single radio access (such as RABx, which is associated only to LTE, and RABz, which is associated only to WLAN). This may be similar in principle to handling WLAN connectivity as a Secondary Cell Group (SCG) of the WTRU's configuration. Such modelling may then include support for transmitting data associated to a bearer using the plurality of radio accesses but which may also be treated as separate transport branches from the perspective of two layer protocols. Specific restrictions for certain traffic or bearers may be introduced by configuration, in some embodiments. For other bearers, dynamic methods may be used to determine uplink routing.

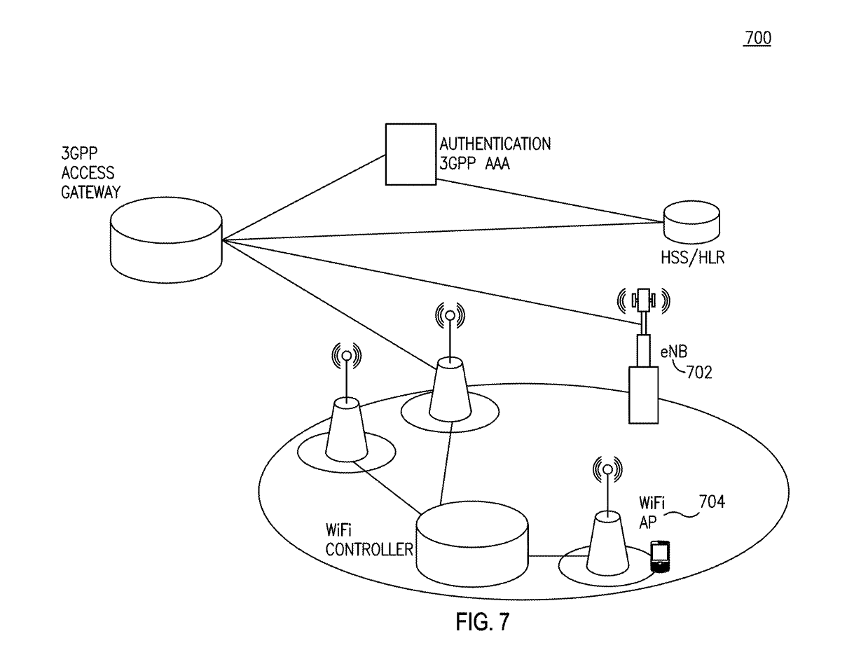

FIG. 7 is a diagram of an example system 700 in which the WLAN AP 704 and the LTE eNB 702 are physically separated without an interface. In the example illustrated in FIG. 7, from the perspective of the network, the implementation of the LTE and WLAN radio accesses may be physically separated, and coordination between them may either be very limited or completely non-existent. In such case, from the WTRU's perspective, the modelling of the user plane may be such that the Layer 2 (L2) of each respective radio access remains unchanged. Instead, additional control plane procedures or behaviors associated to the first radio access may be used, such as to provide control for bearers associated to the second radio access.

The embodiments described herein may take into account different possible approaches to the interactions between both access technologies. For example, in a policing-based operation, one or more WLAN aspects may be integrated with LTE as a black box. In this case, a first access technology, such as LTE, may be implemented to act as a container for a second access technology, such as Wi-Fi. For example, a function that may not be available and/or implemented in the second access technology may instead be enforced and supervised in the first access technology. In another example, a primitive-based operation may be used, where one or more WLAN aspects may be integrated with LTE as a white box. In this case, the first access technology, such as LTE, may be implemented to interact with a second access technology, such as Wi-Fi. For example, the first access technology may have access (e.g., based on implementation aspects such as primitives) to information or notifications associated to a function that may be available and/or implemented in the second access technology. Either or both of these approaches may be used for different combinations of functions.

Embodiments described herein also take into account different possible arrangements in terms of where, in the protocol layers or implementation, different methods or mechanisms may be introduced. Accordingly, opacity and interaction between the different RATs may be addressed from the perspective of LTE implementation. For example, the WTRU may maintain a number of metrics related to the WLAN interface such that they may be available to LTE operation. Such metrics are referenced in many of the embodiments described herein and may be derived by observation, such as when using the policing-based operation, or by using information provided by the WLAN component, such as when using the primitive-based approach. The WTRU may maintain and/or calculate the following metrics in support of the methods described herein (e.g., for methods and mechanisms that may be designed to react, adapt, or adjust to observed Wi-Fi performance: a QoS metric, a packet data-related metric, a buffer/queueing-related metric, and an interface-related metric. Other metrics may also be used. Each of the metrics is described in more detail below and may include average values, absolute values or accumulated values over a configurable or configured period or since a specific event. Further, the metrics may be applicable per bearer, group of bearers, per type of bearer and/or for a given interface, such as WLAN.

QoS metrics may include, for example, a transmission rate for a given aspect or a change thereof by a specific amount. Such rate may be, for example, the available Wi-Fi transmission rate. For example, such rate may be one of a prioritized bit rate (PBR), a guaranteed bit rate (GBR), a maximum bit rate (MBR) and an access point name (APN) aggregate MBR (A-AMBR). Regarding a PBR, for example, the WTRU may be configured such that data associated with a given bearer, or multiple bearers, may be transmitted using the WLAN interface. In an embodiment, the WLAN interface may serve the applicable bearer or bearers at least up to the configured PBR. Regarding a GBR, for example, the WTRU may be configured with a minimum rate value at which a bearer, or a plurality of bearers, may be served. Such rate may be served by the WLAN interface only, such as for routing traffic in the uplink, or using the combination of the LTE and WLAN interfaces, such as for reporting observed rates in the downlink.

Regarding an MBR, for example, the WTRU may be configured with an MBR value at which a bearer, or multiple bearers, may be served. Such rate may be served by only one of the LTE and WLAN interfaces configured for the WTRU. For example, such maximum rate may be configured such that it is applicable to transmissions associated with the LTE interface such that any data exceeding such rate may be a candidate for offloading to the WLAN interface. In this case, if the WTRU determines that the other interface is not sufficient for the amount of data exceeding this rate, it may determine that the value is not meeting the threshold. For another example, such maximum rate may be configured such that it is applicable to transmissions associated with the WLAN interface such that any data exceeding such rate may be considered to overshoot the offload capability of the interface. In this case, the WTRU may consider such excess data as a candidate for transmission (including for buffer status reporting) using the LTE interface and/or it may be determined that the value for this metric is not meeting this threshold. Similar approaches may be used for other rate-based metrics, such as PBR, GBR and A-AMBR.

Regarding A-AMBR, for example, the WTRU may be configured with a maximum bit rate value at which a bearer, or multiple bearers, may be served. The multiple bearers may correspond to a single APN and may consist only of non-GBR bearers. Such rate may be served by only one of the LTE and WLAN interfaces configured for the WTRU.

Another QoS measurement may be an error rate or change thereof. For example, such an error rate may be a Packet Error Rate (PER), a Packet Loss Rate (PLR), or an average number of retransmissions. The WTRU may use indications from the WLAN interface, such as for the uplink error rate, and/or sequence numbering information, such as observed from reception of PDCP protocol data units (PDUs) on the WLAN interface or, for example, as indicated in a status report PDUs associated to the WLAN interface, to determine what packets may be missing. Alternatively, such quantity may be an absolute number of missing packets, consecutive or not, which may be within a transmission/reception window.

Packet data-related metrics may include, for example, a timing aspect, such as a value related to the service data unit (SDU) discard timer and/or a time of stay in the WTRU's buffer, a sequencing aspect, a feedback aspect and duplicate detection. Regarding the timing aspect, it may be an average, a worst-case, a change in average, or a head-of-line value, for example. Different arrangements of what SDUs/PDUs may be considered are possible, such as based on elapsed time, remaining time, whether or not the transmission is still ongoing, whether or not the timer was stopped due to successful transmission, the period concerned, a sequencing aspect related to the SDU/PDU, or an association with a specific buffer and/or interface (e.g., WLAN). Such metrics may be used, for example, to determine whether such value is below or above a threshold. Regarding the sequencing aspect, this may be, for example, the length/size of a sequence number (SN) gap in a received/transmission window. Regarding the feedback aspect, it may be, for example, information received from a PDCP status report that acknowledges, positively or negatively, one or more SDUs or PDUs. Regarding duplicate detection, a WTRU may determine that a number of duplicate data units have been received or transmitted, for example based on received status reports.

Buffer/queueing-related metrics may include, for example, a buffer fill-rate, a buffer emptying rate, a variation in empty/fill rate, an average time in buffer/delay, or a head-of queue-delay.

Regarding interface-related metrics, a WTRU may consider the following metrics, for example, for a given interface, such as the WLAN interface: link quality, transmission rate, and timing aspect. The link quality may include, for example, measurements and packet error rate (PER). The transmission rate may include, for example, the average or instantaneous transmission rate or change in such rate. The time aspect may include, for example, access latency, time required for medium reservation/acquisition, a backoff time or an average backoff time, an average time of data in buffer/transmission delay, head-of-queue delay, a load aspect (e.g., an estimated load for the WLAN access or a change in such estimated load), a rate of contention loss/success for contention-based access, an average time to win contention, and an estimated transmission rate of available power (e.g., insufficient available transmission power).

Embodiments are described herein that address different aspects that enable tighter integration between a first RAT, such as LTE, and, a second wireless technology, such as Wi-Fi. For example, embodiments are described that enable an eNB to configure, activate and associate with a WLAN AP within a set of configured WLAN APs. For another example, embodiments are described that enable the WTRU to derive security parameters for the WLAN connection, for example, without using legacy IEEE 802.XX security procedures. Embodiments are also described that enable a WTRU to report a WLAN status to the LTE RRC in the eNB. Embodiments are also described that enable a WTRU to determine when to send WLAN connection status reports. Further, embodiments are described that enable the WTRU to initiate transmission of a report indicating missing PDUs from a reception buffer in PDCP. In yet another example, embodiments are described that enable a WTRU to handle a configuration for WLAN offload upon an event that may impair connectivity with the eNB.

In the embodiments that are described herein, a WTRU may enable LTE control of a WLAN interface and may use one, or a combination, of different methods and mechanisms to enable such control. For example, state-based integration may be used, where the WTRU may control the state of the WLAN interface separately from the state of LTE connectivity. For example, the WTRU may implement sub-states for the WLAN interface when in LTE RRC Connected mode only. For another example, the WLAN interface may be used as a serving cell of the WTRU's configuration. In this example, the WTRU may control the use of the WLAN interface using principles applicable to a secondary cell (SCell) of the WTRU's configuration. For example, configuration signaling, such as RRC signaling, handling of user plane traffic (e.g., all bearers may be associated with both interfaces), and activation mechanisms (e.g., MAC-based) may be similar to that of a legacy SCell. Some function may, however, not apply, such as functions related to layer 1 (L1) cross-carrier scheduling or transport of Hybrid Automatic Repeat Request (HARQ) feedback. For another example, the WLAN interface may be configured from a cell group of the WTRU's configuration. In this example, the WTRU may control the use of the WLAN interface using principles applicable to a secondary cell group (SCG) of the WTRU's configuration. For example, configuration signaling, such as RRC signaling, handling of user plane traffic (e.g., some bearers may be associated to both interfaces at least in one direction and others may be designated for a single CG only), radio link failure (RLF) handling and notification procedures may be similar to that of a legacy SCG. Some functions may not apply, however, without at least some changes, such as functions related to mobility or SCG failure at least because different triggers may be required.

In embodiments described herein, a WTRU may configure an LTE-controlled WLAN interface for the WTRU, for example, using parameters provided through RRC signaling. For example, a WTRU may receive an RRCReconfigurationRequest message that includes such parameters.

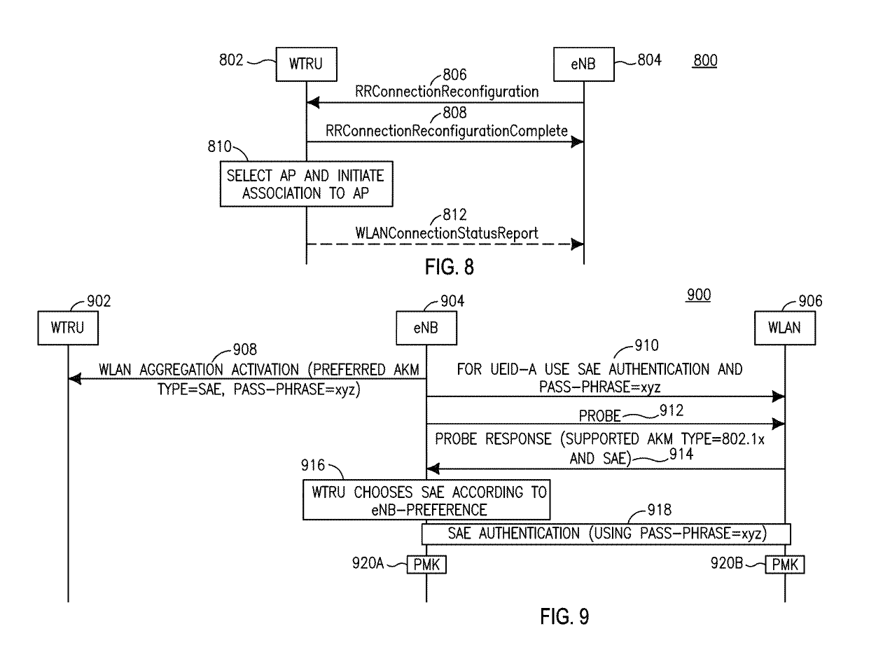

FIG. 8 is a signal diagram 800 showing basic RRC signaling that may be used for any of the embodiments described herein. In the example illustrated in FIG. 8, an eNB 804 may send an RRCConnectionReconfiguration message 806 to a WTRU 802. Such signaling may include, for example, parameters for the WTRU to configure an LTE-controlled WLAN interface and other related parameters, such as traffic steering commands relating to traffic offload. Such parameters may include, for example, a set of WLAN APs, an indication that the WTRU is permitted to autonomously initiate association with a WLAN AP, a type of one or more bearers to use for the LTE-controlled WLAN interface (e.g., split, LTE-only or WLAN-only), WLAN-related security information, and a configuration for the WTRU to report a status of an association with a WLAN AP. Other specific parameters that may be included in the RRC signaling 806 are described in detail below. The WTRU 802 may reply with RRC signaling, such as the RRCConnectionReconfigurationComplete message 808 illustrated in FIG. 8.

The WTRU 802 may perform additional functions, as described in the embodiments below. By way of example, in FIG. 8, the RRC signaling 806 may include a set of WLAN APs and an indication that the WTRU 802 is permitted to autonomously perform association with an AP, such as any suitable WLAN AP within the set. In this example, the WTRU 802 selects a WLAN AP from within the set and initiates association to the selected WLAN AP (810). In an embodiment, the WTRU 802 may also send a WLANConnectionStatusReport 812 to the eNB 804, for example, if configured to do so. For example, using this signaling, the WTRU may report that it has successfully associated with an AP or may provide other configured reporting that is described in more detail below.

In the example illustrated in FIG. 8, the WTRU 802 is configured to autonomously select and re-select a WLAN AP to use for the LTE-controlled WLAN interface from among a provided set of WLAN APs. However, the selection of the WLAN AP may also, or alternatively, be made by the eNB. Embodiments for autonomous WLAN AP selection and re-selection and network-controlled (e.g., eNB-controlled) WLAN AP selection and re-selection are described below.

For WTRU autonomous WLAN AP selection and re-selection, as described above, the WTRU may receive RRC signaling that includes a set of APs and an indication that the WTRU is permitted to autonomously perform association with an AP, such as a suitable AP within the set. In embodiments, the WTRU may determine whether a WLAN AP is suitable by performing measurements on the WLAN APs in the set and determining the best WLAN AP based on the measurements. For network-controlled WLAN AP selection, the WTRU may still perform measurements, but the WTRU may provide reports of the measurements to the eNB or other network entity that may decide which WLAN AP the WTRU should associate with. In some embodiments of autonomous WLAN AP selection, the WTRU may also send measurement reports to the eNB or other network entity.

In general, a WTRU may be configured to report measurement quantities and/or parameters related to the WLAN interface. Such measurement reports may include radio measurement quantities, such as a Received Channel Power Indicator (RCPI), a Received Signal to Noise Indication (RSNI), or other information that the WTRU may acquire from reception of the beacon transmitted by the WLAN AP, from a Probe response received from the WLAN AP or from the reception of other parameters such as generic advertisement. Such measurement reports may also include, for example, load-related quantities, such as BSSload, an estimation of backhaul performance, such as backhaulrate, or any of the other metrics described in detail above.

For purposes of determining a suitable WLAN AP, in an embodiment, the WTRU may be configured with default threshold values for one or more measurement quantity. Such measurement quantity may include a legacy LTE Release 12 measurement, such as an RCPI or an RSNI, or may correspond to BSSload, backhaulrate, or any of the other quantities described in detail above. As described previously, the configuration may additionally include an identity of one or more accessible access networks (ANs), such as based on SSID, BSSID, MAC address of an AP or any other similar identifier.

In some embodiments, such default configuration for measurements may be received on the broadcast signaling of a serving cell of the WTRU's configuration, such as from the system information (SI) of a primary cell (PCell) of the WTRU's configuration. Such default configuration may be used to determine, for example, whether or not a suitable WLAN AP is in range of the WTRU, such as by using a discovery process. In an embodiment, the default configuration may be similar to the legacy LTE Release 12 configuration. The configuration may include an indication of whether or not the WTRU may autonomously perform the association procedure to a suitable WLAN AP.

In embodiments, the WTRU may perform measurements and/or discovery of a suitable WLAN AP for simultaneous LTE and WLAN operation, for example, by first using a default configuration once the WTRU has reported capability for such type of configuration and operation. This may be the case, for example, only if the WTRU determines that it is not currently associated to a WLAN AP for the WLAN interface, whether it is under LTE control or not.

In an embodiment, the WTRU may perform such measurements and discovery of a suitable WLAN AP first if it has received an indication in RRC signaling, such as the RRCConnectionConfiguration or RRCConnectionReconfiguration message that instructs the WTRU to perform such measurements and discovery. For example, a WTRU may have reported suitable capability information but may first consider WLAN measurements for the purpose of LTE control when instructed to do so. When the WTRU receives such instruction, it may use the default configuration.

In embodiments, the WTRU may be configured with one or more configuration aspects for measurement and/or discovery of a suitable WLAN AN (e.g., a WTRU-dedicated configuration). Such a configuration may override, at least in part, any similar broadcasted configuration (e.g., a cell-specific configuration).

In some circumstances, such as if the WTRU has reported measurement quantities related to WLAN using the default configuration, the WTRU may receive a first dedicated configuration for WLAN operation, such as in support of mobility procedure. Examples of such mobility procedures may include WTRU-autonomous procedures and network-controlled procedures.

The WTRU may also be configured to perform WLAN measurements, such as through legacy LTE Release 12 WLAN-related measurements. Such measurements may define conditions for triggers for a mobility event, such as if it is determined that LTE is better than WLAN or WLAN is better than LTE.

With respect to measurements, when the WTRU is provided with a set of WLAN APs, such as in the RRC signaling described above, the set may be provided as a list, such as an ordered list, for purposes of performing measurements (e.g., sequentially) and/or reporting using an applicable measurement configuration. The list may include an identity for each AP, such as the BSSID, SSID, and/or MAC address, as described above.

In embodiments, the WTRU is configured for LTE-controlled WLAN offload using the LTE-controlled WLAN interface. In such embodiments, a WTRU in an RRCActive state may be configured with a WLAN interface and an LTE interface, both of which may be simultaneously active. In such embodiments, a WTRU that is configured for LTE-controlled WLAN offload may additionally report events, such as described above, using layer 3 (L3)/RRC signaling. In embodiments, the WTRU may perform measurement reporting for the WLAN interface by including radio-related measurements such as RCPI/RSNI. Additional triggers may be used to report additional metrics, such as described above.

In embodiments, the WTRU may report a capability for specific measurements related to the WLAN interface. For example, the WTRU may report that it supports measurement capabilities according the IEEE 802.11k specifications. In such case, the WTRU may be configured to report radio-related measurements using RRC signaling, such as in an RRC measurement report.

In some circumstances, a WTRU may report certain additional metrics based on triggers. For example, the WTRU may be configured to send reports when a metric for the serving AP is less than a threshold, when a neighbor AP becomes offset better than the serving AP, when a metric for a neighbor AP is higher than a threshold, or any combination thereof. For example, a WTRU may be configured to send a report on a condition that BssLoad for a neighbor AP is below a threshold and RCPI/RSNI for the same neighbor AP is offset better than for the serving AP. The metrics described in this paragraph (or estimates thereof) may correspond to a quantity, such as any of the quantities or metrics described above, such as BssLoad or BackhaulRate.

In embodiments, a WTRU may support aperiodic requests to trigger one or more configured measurements. Such requests may include, for example, a measurement configuration (and index thereto) to use for the request. In an embodiment, such request may additionally trigger a reporting of the concerned (e.g., configured and/or requested) measurement quantities. Such a request may be received, for example, using signaling on the LTE interface, such as L1 signaling (e.g., on physical DL control channel (PDCCH)), L2/MAC signaling (e.g., in a MAC control element) or L3/RRC signaling on a Signaling Radio Bearer (SRB).

For WTRU-autonomous mobility, as mentioned above, the WTRU may select a suitable AP based on measurements, which may be configured. In an embodiment, the WTRU may also perform autonomous re-configurations, such as by determining that it should perform mobility from one WLAN AP to another WLAN AP. The WTRU may make an autonomous decision to perform such mobility, for example, based on any of the measurements/measurement configurations described above.

By way of example, a WTRU may autonomously determine that a procedure for WLAN AP mobility should be performed. In such case, the WTRU may determine that the current (or source) WLAN AP is no longer suitable for transmission. The WTRU may be configured to autonomously adjust the uplink routing in such case. For example, the WTRU may route any data unit for some or all bearers associated at least in part to the WLAN interface to the LTE interface, for example, from the start of the procedure until the mobility procedure is successfully completed. For example, the WTRU may perform such routing adjusting for bearers configured for split operation.

In embodiments, the WTRU may notify the network (e.g., eNB) that the WTRU has updated the routing. For example, the WTRU may initiate transmission of such a notification, which may be, or may include, a status report using the LTE interface. In an embodiment, the status report may be a PDCP SR. The WTRU may initiate such a procedure, for example, when it determines that is may no longer perform any transmission using the source AP and/or when it updates the uplink routing due to a mobility event. For example, this may be desirable if LTE is used for retransmissions of any missing data units during the mobility procedure (e.g., when split bearers are used for split operation). In such a case, the WTRU may include a status report only for such bearers.

In embodiments, the WTRU may initiate such a procedure when it determines that it may perform transmission using the WLAN interface following a change of WLAN AP. For example, this may be desirable if WLAN is used for retransmissions of any missing data units following the mobility procedure (e.g., when bearers configured for WLAN-only operation are configured). In such a case, the WTRU may include a status report only for such bearers.

The WTRU may report an identity of the target WLAN AP (e.g., based on BSSID, SSID or MAC address). In an embodiment, the WTRU may also report the identity of the source AP (e.g., the AP that the WTRU is no longer connected to).

For network-controlled AP selection and re-selection, a WTRU may receive a configuration for a particular WLAN AP to use for the LTE-controlled WLAN interface and may also later receive a reconfiguration that initiates a change of the WLAN AP and/or a reconfiguration of the bearers (at least in part) associated to the WLAN interface. For example, the WTRU may receive a reconfiguration that changes the serving WLAN AP.

For example, the WTRU may receive a reconfiguration that changes the configuration of one or more bearers associated at least in part to the WLAN interface. The reconfiguration may modify the bearer such that corresponding data units may no longer be transmitted using the WLAN interface. In such a case, the WTRU may initiate a change in routing for the user plane such that cumulative retransmissions may be performed in the uplink using the LTE interface. In an embodiment, this may be done only if indicated. In an embodiment, the WTRU may receive a status report, such as a PDCP SR, such that only data units indicated in the report may be retransmitted using the LTE interface. In an embodiment, the WTRU may initiate the transmission of a status report for the applicable bearers.

In an embodiment, the WTRU may receive a reconfiguration that changes the configuration of one or more bearers associated to LTE only. The reconfiguration may modify the bearer such that corresponding data units may be transmitted, at least in part, using the WLAN interface. In such case, the WTRU may initiate a change of routing for the user plane, but it may not require performance of any additional retransmission in the uplink. The WTRU may complete any pending transmission or transmissions using the LTE interface.

With regard to WLAN mobility, a WTRU may receive a reconfiguration that changes the configuration of one or more bearers associated, at least in part, to the WLAN interface. The reconfiguration may modify the configuration of the WLAN interface such that a different AP may be used (e.g., WLAN AP mobility). In such a case, the WTRU may initiate a change in routing for the user plane such that cumulative retransmissions may be performed in the uplink using the LTE interface. In an embodiment, this may only be done if indicated, and, otherwise, retransmissions to the target WLAN AP may be applicable, at least during the mobility procedure. In an embodiment, the WTRU may initiate the transmission of a status report for the applicable bearers.

In an embodiment, the WTRU may be configured to perform retransmissions for a given bearer using the LTE interface for such a procedure. The WTRU may receive a status report such that only data units indicated in the report may be retransmitted using the WLAN interface.

In an embodiment, the WTRU may be configured to perform retransmissions for a given bearer using the WLAN interface for such a procedure. The WTRU may receive a status report such that only data units indicated in the report may be retransmitted using the WLAN interface.

In embodiments, a WTRU may receive control signaling for steering user plane traffic between the LTE and WLAN interfaces. Such signaling may be, for example, L1/PDCCH signaling, L2/MAC signaling, or L3/RRC signaling. Such traffic steering may be performed per bearer, group of bearers, or per type of bearer. Such control signaling may be used to steer the user plane traffic. In an embodiment, the WTRU may have previously reported WLAN-related measurements and/or information, such as described above.

From the network perspective, the decision to steer traffic may be based on one or more aspects, such as QoS class identifier (QCI) for the applicable bearer or bearers, received measurements from the WTRU, and/or other WTRU-assistance information, user preference, PDN offloadability, or ANDSF preference. In an embodiment, the WTRU may provide information to the network regarding what bearer may be offloaded to WLAN. Such control signaling may include one or more reconfiguration aspects for the concerned bearer or bearers, such as whether the offload should be only for downlink traffic, only for uplink traffic, for both, and/or whether or not each type of offload is for a split bearer.

As described above, the WTRU may receive a reconfiguration message, such as an RRCConnectionReconfiguration message, that adds the WLAN interface to the WTRU's configuration. In the embodiment described with respect to FIG. 8, this may be done, at least in part, by providing the set of WLAN APs and the indication that the WTRU is permitted to autonomously perform association with a WLAN, such as any AP within the set that, for example, the WTRU determines to be suitable.

For any of a number of reasons, the WTRU may determine that it cannot comply with the reconfiguration. In such a case, the WTRU may initiate the transmission of a message that indicates that the configuration that adds the WLAN interface to the WTRU's configuration was not successful and, in an embodiment, may include a cause for the non-compliance. In an embodiment, the message may be a response to the RRCReconfigurationRequest, such as an RRCReconfigurationComplete message with a failure indication. In this case, the WTRU may maintain the LTE connection and continue operating using the LTE configuration applicable at the time of reception of the RRC message. In an embodiment, if the RRC Reconfiguration message included a separate reconfiguration for the LTE interface, the WTRU may perform such reconfiguration and send a complete message for the LTE reconfiguration only to indicate that it could comply to that part, if that is the case. Similar behavior may be used for a reconfiguration that modifies the WLAN AP (e.g., a WLAN mobility event).

As described above, the RRC signaling, such as the RRCConnectionReconfiguration message, may include a configuration for the WTRU to report a status of an association with a WLAN AP. This may be one example of a cause for the inability for the WTRU to comply with the RRC Reconfiguration, as described above. The WTRU may, however, determine that it may not comply with the reconfiguration that adds a WLAN for a number of different reasons. For example, the WTRU may fail to configure or re-configure the WLAN interface according to the received reconfiguration message (or equivalent). Further, the WTRU may fail to determine that the configured WLAN may provide a suitable offload service. For example, the WTRU may fail to move to an “on” (or equivalent state), which will be described in more detail below, for the WLAN interface (e.g., the WTRU may not be successful in associating with a configured AP), to acquire a transmission resource, to receive broadcast information, to receive a probe response, to establish WLAN-related security or to complete similar procedures to enable transmission of (e.g., LTE PDCP) data units. In an embodiment, a timer may be provided in the RRC signaling, which may be configurable, and an inability to comply with the reconfiguration may be detected if the WTRU is unable to determine that a WLAN interface is suitable for the offload service before the timer expires. For another example, one of the metrics, such as described above, may fail to meet a minimum threshold, which may trigger the failure reporting.

The WTRU may also control the use of the WLAN interface using a number of different methods. In some embodiments, the WTRU may use RRC-related WLAN sub-states to control the WLAN interface. Further, in some embodiments, the WTRU may control use of the WLAN interface using principles applicable to an SCell of the WTRU's configuration. Even further, in some embodiments, the WTRU may control the use of the WLAN interface using principles applicable to a secondary cell group (SCG) of the WTRU's configuration.

For embodiments where RRC-related WLAN sub-states are used to control the WLAN interface, the WTRU may control the state of the WLAN interface using additional states specific to the WLAN operation. Such states (and change thereof) may be handled separately from the LTE states. Such states may, however, interact with and/or impact other LTE procedures in a given state. Such state may correspond to the ability of the WTRU to transmit and receive data using the WLAN interface and, in an embodiment, with a certain minimum for a specific set of metrics. Such metrics may be based on available data rate, load (estimated or indicated by the WLAN AP) or a metric similar to those described above.

For example, the WTRU may implement sub-states for the WLAN interface when in LTE RRC Connected mode only. Such states may include an “on”/“off” state (e.g., non-zero or zero available data rate) and other states, such as “Associated” (e.g., AP association complete and active in transmissions) and “IDLE” (e.g., suitable AP in range not associated). The “off” state may be associated with different causes, such as no suitable AP in range, available rate less than a minimum threshold value, Wi-Fi radio inactive (e.g., turned off by user), or Wi-Fi radio busy (e.g., used as a non-LTE controlled access).

In embodiments, the WTRU may determine that there is an RLF for the LTE interface. The WTRU may remove any configuration related to the LTE-controlled WLAN interface (e.g., LTE-related traffic may no longer be transmitted using the WLAN interface). Alternatively, the WTRU may continue transmitting data units using the WLAN interface. In an embodiment, the WTRU may only continue transmitting data units using the WLAN interface until the end of the RRC re-establishment procedure. In an embodiment, this may only be applicable for bearers that are associated to WLAN only. In an embodiment, the WTRU may include information related to the configuration of the WLAN interface, such as associated AP (e.g., SSID, BSSID, or MAC address), in the RRCConnectionRe-establishment message.

On a condition that the WTRU determines RLF for the LTE interface, the WTRU may trigger the dual stack mobile IP (DSMIP)-based IFOM procedures or the network-based IFOM procedures to move the traffic from the “PGW->eNB” path to the “PGW->TWAN” path, if the WTRU determines that the AP supports the function. In an embodiment, if the WTRU determines RLF for the LTE interface and before (or until) the WTRU may determine a successful outcome for the LTE re-establishment procedure, the WTRU may continue transmissions for one or more bearers that are, at least in part, associated to the WLAN interface. In an embodiment, this may only be applicable for bearers that are only associated to the WLAN interface.

Similarly to the WTRU's behavior when it detects RLF, in an embodiment, the WTRU may be configured to release the LTE-controlled WLAN interface when the WTRU determines that it transitions from RRCConnected mode to LTE IDLE mode. For example, the WTRU may declare SCG-RLF (or equivalent) when it determines that the WLAN interface may no longer provide suitable offload services (e.g., for the configured bearers). The WTRU may initiate an uplink notification procedure when it performs such determination (e.g., as described in other related embodiments herein).

For embodiments where the WTRU controls use of the WLAN interface using principles applicable to an SCell of the WTRU's configuration, as mentioned above, the WTRU may receive at least one parameter, using RRC signaling, for a type of one or more bearers to use for the LTE-controlled WLAN interface. Where SCell principles are used to control use of the WLAN interface, the WTRU may be configured (e.g., using RRC signaling) such that one or more data units from any bearer may be associated to any one of the two interfaces (e.g., at least for initial transmission of a PDCP SDU/PDU). For example, the type of bearer may be split bearer, where the one or more bearers may be associated with both the WLAN and LTE interfaces in at least one direction, or may be a bearer associated to only one of the WLAN or LTE interfaces. In embodiments, retransmission of a PDCP SDU/PDU may be performed using a different interface than a previous transmission attempt. For example, the WTRU may be configured such that only user plane traffic may be associated to the WLAN interface.

In embodiments, the WTRU may be configured with a timer that may control whether or not the WTRU may offload data units to the WLAN interface. Such timer may be a deactivation timer (or similar), and the WTRU may start (or restart) such timer to its configured value on a condition that at least one of the following occurs: the WTRU makes data available for transmission to the WLAN interface (e.g., uplink direction), the WTRU receives a confirmation of successful transmission (e.g., for a previous uplink transmission using Wi-Fi), and/or the WTRU successfully receives data using the WLAN interface (e.g., downlink direction). If the WTRU receives a confirmation of successful transmission, such confirmation may be local to the WTRU, such as from an indication of the WLAN component, or it may be received from the eNB, such as over the LTE interface (e.g., using a PDCP Status Report (PDCP SR) that confirms successful transmission of a PDCP PDU/SDU with a specific SN value that corresponds to a data unit previously sent using the WLAN interface. Such timer may be applicable for a given direction (e.g., uplink or downlink) or for both, for the WLAN interface.

For embodiments where the WTRU controls use of the WLAN interface using principles applicable to an SCG group of the WTRU's configuration, the WTRU may be configured such that one or more bearers may be uniquely associated to the WLAN interface (e.g., a WLAN only RB) or such that one or more bearers may be associated to both the LTE and the WLAN interfaces (split bearer). The configuration of the radio bearer type may use a procedure similar to that described above for controlling the WLAN interface using principles applicable to an SCell of the WTRU's configuration and, therefore, is not described further here. For a split bearer, the WTRU may be permitted to transmit using either interface according to specific rules (e.g., based on rate control for the offload from LTE to WLAN) or based on a state of the WLAN interface, such as any of the potential states described above.

For example, the WTRU may modify the routing of the data units for a split bearer as a function of the state of the WLAN interface. When the WLAN interface is not active, the WTRU may route all data units for the concerned bearer using the LTE interface and, conversely, when the WLAN interface becomes active, the WTRU may begin to offload at least some of the data units, or all of the data units when the rate control is a gating function, for the concerned bearer for transmission using the WLAN interface. In an embodiment, the latter may use a rate control function to determine how much of the data units to offload.

In embodiments, the WTRU may also receive parameters in the RRC signaling, such as the RRCConnectionReconfiguration message, which may be required or used by the WTRU for association to a WLAN AP. Such parameters may be received, for example, in an RRCConnectionReconfiguration message that adds or changes the configuration of the WLAN interface. In an embodiment, such configuration may also include a time to wait before the WTRU is permitted to initiate a transmission to an AP. In an embodiment, the WTRU may receive parameters related to the association with an applicable AP. In such an embodiment, the WTRU may optionally perform the association procedure (e.g., it may skip the procedure). This may be possible, for example, if the eNB and the WLAN AP have previously exchanged a configuration of the association for the WTRU ahead of the WTRU accessing the WLAN AP.

As described above, the RRC signaling, such as the RRCConnectionReconfiguration message, may include WLAN-related security information, which may be used by the WTRU to initiate association to a WLAN AP. Several different methods and mechanisms are described herein that address security for LTE and WLAN integration. As with the parameters used for association with the WLAN AP, WLAN-related security information may be provided, in an embodiment, in an RRCConnectionReconfiguration message that adds or changes the configuration of the WLAN interface. In some embodiments, such as described above, the eNB may provide at least some of the WLAN-related security information needed for the WLAN/AP association. In other methods, security for LTE and WLAN integration may be handled in other manners.

In embodiments, security for LTE and WLAN integration may be addressed using cellular-assisted authentication for access control to WLAN. For example, a WTRU may be challenged by the cellular network (e.g., eNB or MME) over the cellular air interface (e.g., LTE air interface) to verify an authentication token (AUTN) before the WTRU is allowed access over a WLAN network. The WTRU may receive such challenge, for example, in the NAS AUTHENTICATION REQUEST message over the cellular air interface (e.g., from the MME) or may receive such challenge in an RRC message, such as a security activation message for WLAN connectivity over the cellular air interface (e.g., from the eNB). The WTRU may verify the authentication token and generate a result value (RES), which the WTRU may send to the cellular network (e.g., MME or eNB) over the cellular air interface so that the WTRU may be authenticated for access to one or more WLAN networks. For example, the WTRU may send the RES value in the NAS AUTHENTICATION RESPONSE message over the Cellular air interface.

Alternatively, or in addition, the WTRU may be configured to report, to the cellular network (e.g., MME, eNB), one or more Network Access Identifiers (NAI) realms of WLAN networks for one or more operators or service providers for which it has security credentials. Such configuration may be through L3/NAS or RRC signaling. The WTRU may report, to the cellular network, one or more NAIs for one or more WLAN networks.

Alternatively, or in addition, the WTRU may be challenged by the cellular network (e.g., MME) over the cellular air interface to verify one or more authentication tokens (AUTN), with at least one authentication token for the verification of the WTRU credentials for access to a cellular network and at least one authentication token for the verification of the WTRU credentials for access to a WLAN network.

Alternatively, or in addition, the WTRU may generate and send, over the cellular air interface, one or more authentication token verification result (RES) values, with at least one RES value for the verification of the WTRU credentials for access to a cellular network and at least one RES value for the verification of the WTRU credentials for access to a WLAN network. The WTRU may report, to the cellular network, its capability to support verification, over the cellular air interface, of its credentials for access to a WLAN network. In embodiments, the WTRU may use the security credentials derived from the authentication verification to compute ciphering keys and integrity keys that the WTRU may use to cipher and protect the integrity of the data transfer over a WLAN interface.

By way of a specific example, an NAI may be 0 234 150 999999999@wlan.mnc150.mcc234.3gppnetwork.org. In this example, ‘0’ indicates that the NAI corresponds to EAP-AKA authentication, and “1,” for example, may refer to EAP-SIM. Further, in this example, 234 150 999999999 corresponds to the mobile IMSI.

In embodiments, security for LTE and WLAN integration may be addressed by bypassing IEEE 802.1X EAP procedures. For example, a WTRU may be configured to begin transmitting data meant for the cellular access network (e.g., eNB) over the WLAN interface upon successful completion of the association procedure (e.g., reception of the IEEE 802.11 Association Response message and without the execution of an EAP authentication procedure, such as the IEEE 802.1X EAP authentication procedure. After successful completion of the association procedure (e.g., after the reception of the IEEE 802.11 Association Response message) and without the execution of an EAP authentication procedure (e.g., IEEE 802.1X EAP authentication procedure), the WTRU may begin transmitting data (e.g., data meant for the cellular access NW such as the eNB). The WTRU may be configured with one or more WLANs for which the WTRU may begin transmitting data meant for the cellular access network (e.g., eNB) over the WLAN interface upon successful completion of the association procedure and without the execution of an EAP authentication procedure (e.g., 802.1X EAP authentication procedure). The WLANs may be identified by WLAN identifiers, such as BSSID (or AP MAC address), SSID, HESSID, NM, or any combination thereof. Such configuration may be received, for example, using L3/RRC signaling.

In embodiments, the WTRU may be configured to ignore the EAP identity request (e.g., in the IEEE 802.1X EAP Request message) from one or more WLANs. Additionally, or alternatively, the WTRU may be configured with the identification of the traffic (e.g., Bearer ID or virtual AP MAC address assigned to each bearer) whose data packets may be transmitted toward the cellular access network (e.g., eNB) over the WLAN interface after the completion of the IEEE 802.11 association procedure and without the execution of an EAP authentication procedure (e.g., IEEE 802.1X EAP authentication procedure). The WTRU may use this traffic identification to determine which traffic can be transmitted over the WLAN interface upon completion of the IEEE 802.11 association procedure and without the execution of an EAP authentication procedure.

Additionally, or alternatively, the WTRU may provide, to the cellular network (e.g., eNB or MME), a unique identifier, which the cellular network may use to associate the WTRU to a specific WLAN or use in reference to the WTRU context in a specific WLAN and to bypass the EAP procedure and unblock the controlled port in the WLAN. The WTRU may include the identifier in at least the first IEEE 802.11 MAC PDU transmitted to the WLAN after a successful association procedure (e.g., upon receiving the IEEE 802.11 Association Response). For example, the identifier the WTRU reports to the cellular network (e.g., eNB or MME) may be the WTRU MAC address for the WLAN interface. The WTRU may set, in at least the first packet transmitted to the WLAN after a successful association procedure (e.g. upon receiving the IEEE 802.11 Association Response), the transmitter address (TA) to the WTRU MAC address reported to the cellular network.

Additionally, or alternatively, the first data packet the WTRU transmitted over the WLAN interface after the association may be a special higher layer data packet (e.g., a special PDCP PDU). The WTRU may include, in this packet, a unique identifier, which may identify the WTRU in the cellular network. This identifier may be different from the identifier the cellular network uses to associate the WTRU to a specific WLAN or uses in reference to the WTRU context in a specific WLAN.

Additionally, or alternatively, the WTRU may provide the cellular network with its capability to support the procedure to bypass the authentication and key agreement procedure (e.g., EAP family of procedures, such as EAP-AKA', EAP-AKA or EAP-SIM).

In embodiments, security for LTE and WLAN integration may be addressed using a network-controlled selection of an authentication method. In such embodiments, it may be assumed that both the WLAN and the WTRU support RSNA-based authentication/encryptions. Pre-robust security network association (RSNA), such as wired equivalent privacy (WEP), is not considered herein.

In embodiments using a network-controlled selection of an authentication method, when the eNB activates the LTE/WLAN aggregation for a WTRU, or redirects the WTRU from a currently connected WLAN to another target WLAN, it may also instruct the WTRU as to which authentication and key management (AKM) suite (or authentication type) should be used or preferred when accessing the target WLAN. For example, if both the target WLAN and WTRU support multiple AKM suites, such as IEEE 802.1X based authentication and simultaneous authentication of equals (SAE)-based authentication, it may instruct the WTRU to use the SAE based authentication, which may be simpler than IEEE 802.1X based authentication and may shorten the access time for authentication.

The eNB may use the same RRC procedure for activating LTE/WLAN aggregation (e.g., RRC connection reconfiguration) to instruct the WTRU of the preferred AKM suite. The eNB may indicate a preferred AKM suite, such as SAE or pre-shared key (PSK), that is invarious to any target WLAN, or it may indicate a preferred AKM suite for each specific WLAN by associating the preferred AKM suite with the identifier of a specific WLAN. If the eNB-indicated AKM suite is not supported or used by the WTRU or target WLAN, the WTRU may ignore the eNB-indicated choice and follow the normal procedure to choose the AKM suite.

The WTRU may also report to the network its support for WLAN AKM suites, prior to the LTE/WLAN aggregation, via an RRC or NAS procedure so the eNB may make a more meaningful choice/preference for the WTRU to select an AKM suite. The eNB may also retrieve the supported AKM information from the WLANs to which it has a connection/interface for LTE/WLAN aggregation so it can make a WLAN-specific choice or preference. The eNB may also retrieve this information via a WLAN Logical Node (WLN) that may be between the eNB and WLANs.

If a WLAN is capable of supporting multiple AKM suites, but for some reason only includes one configured AKM suite (such as IEEE 802.1X based), in its beacon or probe response frames, the eNB may instruct the WTRU to ignore the RSNE information in the beacon or probe response frames and use the eNB-preferred authentication type. In that case, the eNB needs to also inform the WLAN that this preferred authentication method will be used for a specific WTRU, regardless of its configured authentication policy. In this case, the WLAN may use different authentication methods for WTRUs activated with LTE/WLAN aggregation and other WTRUs respectively.

Specifically, the eNB may instruct the WTRU to not invoke any AKM procedure at all. In this case, the WTRU or AP may establish the association without any RSNA based authentication and key generation (the legacy Open Authentication procedure before the association request/response may still be there), and they should be ready to send/receive the data without any encryption/decryption after the association and depend totally on the LTE PDCP to provide the data privacy. Of course the eNB may need to configure the WLAN for which WTRUs the authentication/encryption should be skipped.

In embodiments, security for LTE and WLAN integration may be addressed using a network-assisted key assignment. In the example embodiments using network-assisted key assignment, it may be assumed that both the WLAN and the WTRU support RSNA based authentication/encryptions. Pre-RSNA, such as WEP, is not described herein.

FIG. 9 is a signal diagram 900 of an example of a security procedure for LTE and WLAN integration using network-assisted key assignment. In the example illustrated in FIG. 9, an eNB 904 generates a pass-phrase and provides it to both the WTRU 902 and the WLAN 906. The eNB 904 provides the pass-phrase to the WTRU 902 in a message 908, which also provides the identifier for the target WLAN 906 with which the p ass-phrase is to be associated to the WTRU 902 via an RRC procedure such as RRC Connection Reconfiguration. The eNB 904 provides the pass-phrase to the WLAN 906 in a message 910. The eNB 904 may then send a probe 912 to the WLAN 906, which may respond with a probe response 914 indicating that the WLAN 906 supports AKM type IEEE 802.1X and SAE. The eNB 904 may the choose SAE for authentication based on an eNB preference (916). The WTRU 902 and the WLAN 906 may then use the eNB-provided pass-phrase for the SAE authentication procedure 918 and generate PMK 920a/920b out of it. On a condition that the eNB 904 re-directions the WTRU 902 to another WLAN, the eNB 904 may generate a new pass-phrase and update it in the WTRU 902. The eNB 904 may also provide the same pass-phrase and the UEID/MAC address with the pass-phrase associated to it to the target WLAN.

To further shorten the time consumed by SAE-based authentication, the eNB 904 may instruct both the WTRU 902 and the target WLAN 906 to skip the SAE procedure and directly provide a PMK to both parties.

In embodiments, the eNB 904 and the WTRU 902 may respectively derive PMK from an EPS-AKA generated key, such as the KeNB or a Kenb-up-enc that is already available at both the eNB and the WTRU, so the eNB does not need to send the PMK to the WTRU. The eNB will, however, still need to provide the WLAN with the PMK that has been derived from the EPS-AKA key.

In other PSK embodiments that do not involve an SAE authentication procedure and directly use a pass-phrase as PMK, the eNB may similarly provide the pass-phrase/PMK to both parties. Similarly, if the IEEE 802.1X/EAP-based authentication is to be used, the eNB may instruct both the WTRU and the target WLAN to skip the IEEE 802.1X/EAP procedures and directly install a PMK at both parties. The four-way handshake that follows may remain the same.

Embodiments are also described herein that may improve reliability of a WTRU configured with an LTE-controlled WLAN interface. In embodiments, the WTRU may monitor the connectivity of the WLAN interface and may use similar measurements to the ones described in detail above. The WTRU may use indications provided from the WLAN interface (e.g., if a white box approach is possible). The WTRU may use one or more aspects for the WLAN interface, such as those described elsewhere herein (e.g., if a black box approach is used).

In embodiments, the WTRU may determine that the quality of the WLAN interface is no longer suitable, such as in relation to the combined traffic requirements of the configured bearers applicable to the WLAN interface. The WTRU may also determine that the WLAN interface is no longer available for LTE-control, such as based on user intervention (e.g., WLAN may be turned off by the user, the user may have selected a different WLAN AP, or the user may have turned off the possibility for LTE-controlled offload), based on a priority for a different type of offload (e.g., based on operator policy, based on power savings for the WTRU, or based on any other such impairment for the WLAN interface).

In embodiments, when the WTRU determines that the quality of the WLAN interface is no longer suitable, it may initiate a procedure to notify the network of the situation and may include a cause, which may be related to the metric and/or measurement that triggered the procedure. A WTRU configured to perform WTRU-autonomous mobility and/or a WTRU configured with one or more split bearers (at least for the uplink direction) may additionally perform procedures such as described above.

In embodiments, the WTRU may trigger a procedure similar to the LTE Release 12 SCG failure information for dual connectivity. In such case, the WTRU may set the failure type to indicate radio link failure and may include additional assistance information and/or WLAN-related measurements.

By way of example, a WTRU may monitor for failure of the WLAN interface or performance degradations thereof. Such monitoring may be based, for example, on one or more of load estimation/detection in the WLAN cell (e.g., based on WLAN AP transmitted BssLoad information), observed failure rates (e.g., packet error rate), or other channel quality related measurements (e.g., RCPI/RSNI). On a condition that the WTRU determines and/or detects that there is a radio link problem for the WLAN interface, the WTRU may initiate a notification, which may include a cause. Such notification may include a report, which may include one or more measurements and/or link quality related quantities (e.g., load, error rates).

The WTRU may then initiate additional procedures such that data traffic is steered towards the LTE interface. The WTRU may trigger the DSMIP based IFOM procedures or the network-based IFOM procedures to move the traffic from the “PGW->eNB” path to the “PGW->TWAN” path if the WTRU determines that the AP supports such function. The WTRU may interrupt any LTE-related transmission on the WLAN interface, for example, until the WTRU receives an RRCConnectionReconfiguration message the reconfigures the WLAN interface.

In embodiments, the WTRU may initiate the transmission of WTRU capability information on a condition that it determines that a criteria for initiating such procedure is met. The WTRU may implement a procedure, for example, to indicate a change in WTRU capabilities, which may be applicable, in an embodiment, to a subset of the WTRU's capabilities (e.g., for capabilities related to WLAN operation only).

In embodiments, the WTRU may perform such procedure when it is not configured for LTE-controlled offload, such as when the WTRU is not configured with a bearer (at least partly) associated to a WLAN interface. The WTRU may, for example, perform such procedure when WLAN-related measurements (such as described above) are configured. Such criteria may include at least one or more of the following or similar: the WLAN interface is no longer available for LTE controlled offload (e.g., user selection), the WLAN interface is powered down and/or in an off state (e.g., power savings in the WTRU and/or user intervention), the WLAN interface is connected to a WLAN AN (e.g., based on operator policy and/or user selection), a geo-location-based aspect (e.g., the WTRU determines that it is within range of a preferred WLAN AP or in a geographical location where offload is not desired), and a WTRU implementation-specific aspect (e.g., insufficient resources and/or processing power). In an embodiment, the WTRU may initiate such procedure at any time independently of whether or not the WTRU is configured for LTE-controlled offload.

Embodiments are also described herein for implementation-based interactions between LTE and WLAN entities. In embodiments, the WTRU 3GPP Access Stratum (AS) or non-AS (NAS) module may interact with the WTRU's WLAN module to subscribe to one or more notifications. Such notification may be a notification of packet loss, such as a WLAN packet loss event, a notification of change in available WLAN data rate, or a notification of loss of WLAN connectivity (e.g., a WLAN loss event).

The AS module may indicate what notifications it is subscribing to. Such subscription may or may not include an evaluation criteria to trigger such notification in specific cases. Examples of such criteria may include a disassociation or deauthentication frame being sent to, or received from, the connected AP, the beacon frames of the connected AP being missing for a certain period of time, the number of consecutive MSDU transmission errors having reached a threshold, and RCPI or RSNI having remained below a threshold for a certain period of time. For example, the 3GPP AS or NAS module may give the detailed criteria to the WLAN module for detection of loss of WLAN connection. Alternatively, the WLAN module may determine when to provide such notification.

When a WTRU 3GPP module has subscribed to the event of loss of WLAN connection, the WLAN module may notify the 3GPP module upon detection of such an event. The 3GPP module may subscribe to the event notification only when the WTRU receives a configuration for LTE-controlled WLAN operation/offload and/or measurements related to the WLAN interface (e.g., only when the offloading is active and/or when traffic is being offloaded to the WLAN). The 3GPP module may unsubscribe from the event notification when the above conditions are no longer met, such as when there is no traffic being offloaded to the WLAN or the LTE-controlled WLAN offload has been deactivated.

In another example, the WTRU may determine that the WLAN is no longer available based on its own assessment of the performance of the WLAN interface. For example, this may be based on methods related to the evaluation of the PDCP layer performance.

When the WTRU determines that connectivity to the WLAN AN is lost, the WTRU may report the event to the eNB via one or more of the following signaling options. The WTRU may report the failure in an appropriate RRC message to the eNB. For example, if there is an RRC message defined for a WLAN measurement report, the failure event may trigger the sending of such a measurement report message. Alternatively, a MAC CE may be used to report such an event. For example, the MAC Buffer Status Report may be modified to carry such an indication. For example, a special LCG-ID may be assigned, and, if such a LCG-ID appears in the BSR, it may indicate such failure. Such failure event may also trigger a PDCP Status Report in the uplink. Such status report may be extended to carry such indication of a failure event.

In embodiments, the WTRU may autonomously stop UL transmissions over the WLAN when it detects such failure, and it may use the LTE interface to avoid further data loss (e.g., at least until an explicit steering command is received, for example, from the eNB). For the PDCP SDUs that have already been delivered to the WLAN path and have not been confirmed or discarded, the WTRU may re-transmit these SDUs using the LTE interface. If the bearer is offloaded to the WLAN in a split manner, the WTRU may need to keep a record of which data units have been sent over WLAN or over LTE such that the suitable data units may be retransmitted in case of such failure.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, implemented in a wireless transmit/receive unit (WTRU), the method comprising:
receiving Long Term Evolution (LTE) Radio Resource Configuration (RRC) signaling that provides Wireless Local Area Network (WLAN) parameters for the WTRU including a configuration or re-configuration to add or modify one or more radio bearers to operate as LTE-only type or split LTE and WLAN type radio bearers, an indication for the WTRU to steer user plane traffic from WLAN to LTE or from LTE to WLAN, and WLAN-related security information,
adding or re-configuring the one or more radio bearers based on the WLAN parameters received in the RRC signaling; and
steering traffic from WLAN to LTE or LTE to WLAN based on the WLAN parameters received in the RRC signaling.

2. (canceled)

3. The method of claim 1, wherein the method further comprises deriving a pairwise master key (PMK), for use in WLAN authentication, from an eNodeB (eNB) key (K_{eNB}).

4. The method of claim 1, wherein the security information is a pass-phrase, and the method further comprises generating a pairwise master key (PMK), for use in WLAN authentication, from the pass-phrase.

5. (canceled)

6. The method of claim 1, further comprising initiating transmission of a Packet Data Convergence Protocol (PDCP) status report (SR) for applicable radio bearers of the one or more radio bearers on a condition that the WTRU receives a reconfiguration to reconfigure a split LTE and WLAN type of radio bearer to an LTE-only type of radio bearer.

7. The method of claim 1, further comprising:
determining a failure to maintain a WLAN connection; and
sending a PDCP status report, to an eNB, providing an indication of the failure and a cause for the failure.

8. The method of claim 1, wherein the RRC signaling includes a timer, and the method further comprises transmitting a message, to an eNB, indicating that a re-configuration failed on a condition that the WTRU is unable to successfully comply with a reconfiguration that adds a WLAN before the timer expires.

9. (canceled)

10. (canceled)

11. A wireless transmit/receive unit (WTRU) comprising:
an antenna;
a transceiver in communication with the antenna; and
a processor, the transceiver and the processor configured to receive Long Term Evolution (LTE) Radio Resource Configuration (RRC) signaling that provides Wireless Local Area Network (WLAN) parameters for the WTRU a configuration or re-configuration to add or modify of one or more radio bearers to operate as LTE-only type or split LTE and WLAN type radio bearers, an indication for the WTRU to steer user plane traffic from WLAN to LTE or from LTE to WLAN, and WLAN-related security information,
the processor and the transceiver further configured to add or re-configure the one or more radio bearers based on the WLAN parameters received in the RRC signaling and steer traffic from WLAN to LTE or LTE to WLAN based on the WLAN parameters received in the RRC signaling.

12. (canceled)

13. The WTRU of claim 11, wherein the processor and the transceiver are further configured to derive a pairwise master key (PMK), for use in WLAN authentication, from an eNodeB (eNB) key (K_{eNB}).

14. The WTRU of claim 11, wherein the security information is a pass-phrase, and the processor and the transceiver are further configured to generate a pairwise master key (PMK), for use in WLAN authentication, from the pass-phrase.

15. (canceled)

16. The WTRU of claim 11, wherein the processor and the transceiver are further configured to initiate transmission of a Packet Data Convergence Protocol (PDCP) status report (SR) for applicable radio bearers of the one or more radio bearers on a condition that the WTRU receives a reconfiguration to reconfigure a split LTE and WLAN type of radio bearer to an LTE-only type of radio bearer.

17. The WTRU of claim 11, wherein:
the processor and the transceiver are further configured to detect a failure to maintain a WLAN connection and send a report, to an eNB, providing an indication of the failure and a cause for the failure.

18. The WTRU of claim 11, wherein the RRC signaling includes a timer, and the transmitter is further configured to transmit a message, to an eNB, indicating that a re-configuration failed on a condition that the WTRU is unable to successfully comply with a reconfiguration that adds a WLAN before the timer expires.

19. (canceled)

20. (canceled)
